(19) United States
(12) Patent Application Publication
(10) Pub. No.: US 2024/0374047 A1
(43) Pub. Date: Nov. 14, 2024

(54) MATTRESS AND METHOD FOR RECEIVING ORDER FOR MATTRESS

(71) Applicant: airweave inc., Aichi (JP)

(72) Inventor: Motokuni TAKAOKA, Aichi (JP)

(73) Assignee: airweave inc., Aichi (JP)

(21) Appl. No.: 18/290,804

(22) PCT Filed: Jul. 5, 2022
(86) PCT No.: PCT/JP2022/026686

§ 371 Date: Jan. 22, 2024

(30) Foreign Application Priority Data
Jul. 29, 2021 (JP) 2021-124490

(51) Int. Cl. A47C 31/12; A47C 27/00; A47C 31/00

(52) U.S. Cl. CPC A47C 31/123; A47C 27/001; A47C 31/006

(57) ABSTRACT

A mattress in which a vibration is unlikely to be transmitted between different cushion members is provided. The mattress includes a mattress cushion on which a plurality of persons can lie in a left/right direction, the mattress cushion includes a plurality of cushion members that can be separated in the left/right direction, each of the cushion members is formed with a filament three-dimensional bonded member that includes a plurality of filaments, and includes a contact surface that is in contact with another cushion member adjacent to the cushion member and ends of the filaments of the cushion member do not enter the other cushion member adjacent to the cushion member.

### TECHNICAL FIELD

The present invention relates to a mattress which is formed with cushion members, and a method for receiving an order for a mattress.

### BACKGROUND ART

In recent years, attention has focused on a highly resilient mattress which uses a bonded member (filament three-dimensional bonded member) obtained by three-dimensionally fusing and bonding filaments made of a thermoplastic resin because the mattress is highly resilient, is easy to turn over on and is highly breathable.

The filament three-dimensional bonded member has a high porosity (generally around 95%), and thus the filament three-dimensional bonded member can be drained and dried quickly even after being washed with water, with the result that the filament three-dimensional bonded member has the advantage of being easy to clean.

As a method for manufacturing the filament three-dimensional bonded member as described above, for example, a method disclosed in Patent Document 1 is known. In the method described above, a thermoplastic resin in a molten state is extruded downward in a vertical direction from a plurality of nozzles arranged horizontally, a molten filament having a diameter of around 1 mm is thereafter dropped into cooling water, thus loops are formed by the buoyancy of the water and simultaneously, a plurality of molten filaments which form the loops are fused and bonded three-dimensionally and are then cooled to solidify, with the result that the filament three-dimensional bonded member is manufactured. With timing at which the molten filaments are three-dimensionally fused and bonded, a roller and a metal plate are used to regulate the thickness of the molten filaments, and thus it is possible to obtain a filament three-dimensional bonded member having a desired thickness. Immediately after the filament three-dimensional bonded member is manufactured, the continuous filament three-dimensional bonded member having the thickness corresponding to a spacing caused by the roller and the metal plate is provided, and thus the filament three-dimensional bonded member is cut such that a desired size in a length direction (in the direction of travel of a molten filament group) and in a width direction (direction perpendicular to a thickness direction and the length direction) is provided, with the result that a mattress cushion is obtained.

### RELATED ART DOCUMENT

### Patent Document

Patent Document 1: Japanese Patent No. 4966438
Patent Document 2: International Patent Publication No. 2018/150815

### DISCLOSURE OF THE INVENTION

### Problems to be Solved by the Invention

Disadvantageously, however, since the mattress using the filament three-dimensional bonded member is highly resilient, when two persons sleep on a typical double bed mattress 5 (consisting of a cushion member 51 and a mattress cover 50) as shown in FIG. 30, and one of the users turns over, as indicated by a white arrow in FIG. 30, a vibration (vertical vibration) caused by the turning over of the user is easily transmitted to the other user.

On the other hand, when a mattress 6 as shown in FIG. 31, an example of which is a 6-split-type mattress disclosed in FIG. 12 of Patent Document 2, is used, two users can sleep on different cushion members 61 and 62, respectively. The cushion members 61 and 62 are covered with a mattress cover 60.

However, since the filament three-dimensional bonded member has a high porosity of 90% to 98% to have a large number of gaps, in contact surfaces 61F and 62F of the cushion members 61 and 62 adjacent in a left/right direction, a part (in particular, cut ends of the filaments and projections of loops of the filaments) of the filaments of one of the cushion members enters the interior of the filaments of the other of the cushion members, and thus they are in an engaged state.

Consequently, since a large friction force (engagement force) is generated on the contact surfaces, when as shown in FIG. 32, a load W is applied to one of the cushion members such that the cushion member is deformed, the other cushion member is easily deformed accordingly, with the result that it is impossible to sufficiently suppress the transmission of a vibration caused by the turning over of one of the users to the other user. FIG. 32 shows, on the right side, a state where the load W is applied to the cushion member 61, and shows, on the left side, a state where the load W is not applied.

Disadvantageously, furthermore, when the cushion members adjacent in the left/right direction are compressed and contained in the mattress cover 60 such that a gap between the cushion members is prevented from being widened to cause an arm, a leg or the like to fall into the gap, the friction force (engagement force) of the contact surfaces of the cushion members 61 and 62 is further increased, with the result that the vibration caused by the turning over is more easily transmitted.

The present invention is made in view of the problems described above, and an object of the present invention is to provide a mattress in which a vibration is unlikely to be transmitted between different cushion members and a method for receiving an order for the mattress.

### Means for Solving the Problem

A mattress according to the present invention includes: a mattress cushion on which a plurality of persons can lie in a left/right direction, the mattress cushion includes a plurality of cushion members which can be separated in the left/right direction, each of the cushion members is formed with a filament three-dimensional bonded member which includes a plurality of filaments, and includes a contact surface which is in contact with another cushion member adjacent to the cushion member and ends of the filaments of the cushion member do not enter the other cushion member adjacent to the cushion member.

In the present configuration, in the contact surface of cushion members adjacent in the left/right direction, a contact friction force generated by the entrance of ends of the filaments of one of the cushion members (cut ends of the filaments and projections of loops of the filaments) into the filaments of the other cushion member can be reduced, with the result that it is possible to suppress the transmission of a vibration caused by the turning over of one of the users to the other user. More specifically, in the configuration described above, a configuration may be adopted in which in the cushion member, the ends of the filaments do not protrude outward of the contact surface in all regions of the contact surface.

In the configuration described above, the repulsive force of the cushion member may be equal to or greater than 100 N and equal to or less than 200 N, and a contact friction force on the contact surface between the cushion members adjacent to each other may be greater than 0 N and less than 50 N. In the present configuration, since the contact friction force is less than 50 N, the cushion member in which the repulsive force is equal to or greater than 100 N and equal to or less than 200 N is used, and thus the amplitude of the vibration in the contact surface is significantly reduced. Hence, it is possible to further suppress the transmission of the vibration caused by the turning over of one of the users to the other user.

The repulsive force in the present invention can be measured by the following method. A sample for which the repulsive force is measured is first placed on a horizontal stand, the thickness of the sample without being compressed is measured and the measured thickness is assumed to be L1 (mm). Then, a rod-shaped pressure member (loader) in which a circular plate having a diameter of 150 mm is installed horizontally at a tip is brought into vertical contact with the center of the upper surface of the sample, a load is applied to the loader and thus the sample is compressed in a thickness direction. Here, as the thickness of the sample which is compressed, a distance L2 (mm) between the bottom surface of the sample (the upper surface of the horizontal stand) and the tip of the loader (circular plate) is measured, a load when L2 is 7.5 mm shorter than the thickness L1 (mm) of the sample without being compressed (L2=L1−7.5) is measured as a value which includes the weight of the loader and the value (N) thereof is assumed to be the repulsive force.

The contact friction force in the present invention can be measured by the following method. As a sample for which the contact friction force is measured, two adjacent cushion members are cut with contact surfaces left such that rectangular parallelepipeds with a horizontal surface being a 20 cm square are provided. The two cushion members which are cut are sandwiched between two 20 cm square plates in the thickness direction (up/down direction), a pressure of 1000 Pa is applied to the metal plates and thus the cushion members are fixed. Here, the cushion members are fixed with a 2 cm gap provided between one side of the metal plate and the contact surface of the cushion member such that the contact surfaces are not hidden by the metal plates. The two cushion members are brought into contact on the cut surfaces, the two cushion members are pressurized from both sides such that a pressure of 200 Pa is applied to the contact surfaces in a vertical direction, a force is applied from the centers of the metal plates in a direction parallel to the contact surfaces such that in a state where the contact surfaces are in contact at the pressure of 200 Pa, a shear force is applied in the thickness direction of the cushion members and thus the cushion members are made to slide by 5 cm in the thickness direction of the cushion members. The maximum value (N) of the force applied at this time is assumed to be the contact friction force.

In the configuration described above, the cushion member may include a smooth surface layer in the contact surface. In the present configuration, since the cut ends (cuts) of the filaments are not present in the contact surface, not only a static contact friction force but also a dynamic contact friction force can be reduced, with the result that even when a vibration with a large amplitude is generated, the vibration is unlikely to be transmitted on the contact surface. It is assumed that the smooth surface layer here is a layer 2 mm deep from the surface of the cushion member, its bulk density is higher than the inside thereof and the smooth surface layer is a layer in which the cut ends (cuts) of the filaments do not protrude outward of the surface.

A mattress according to the present invention includes: a mattress cushion which includes a plurality of cushion members; and a mattress cover which contains the mattress cushion, the mattress cushion includes the cushion members which can be separated, at least one or more of the cushion members include an electronic component which has a communication function, each of the cushion members is formed with a filament three-dimensional bonded member which includes a plurality of filaments, and includes a contact surface which is in contact with another cushion member adjacent to the cushion member and ends of the filaments of the cushion member do not enter the other cushion member adjacent to the cushion member.

Disadvantageously, although the installation location of the cushion member which includes the electronic component having the communication function can be determined according to the preference of the user, since the cushion member which is formed with the filament three-dimensional bonded member and can be separated has a large contact friction force, it takes much time to fit the cushion member into a predetermined position or the cushion member cannot be completely fitted to cause a step. In this respect, in the present configuration, the contact friction force of the cushion member including the electronic component having the communication function can be decreased, and thus it is easy for the user to fit the cushion member into a desired position. More specifically, in the configuration described above, a configuration may be adopted in which in the cushion member, the ends of the filaments do not protrude outward of the contact surface in all regions of the contact surface.

A method for receiving an order for a mattress according to the present invention is a method for receiving an order for the mattress of the configuration described above in which the cushion members are contained in the mattress cover, the method includes: a cushion information input reception step of receiving, by a first communication terminal on the side of an orderer, an input of cushion information about the cushion member in each of partitions in which the cushion members are individually arranged; a cushion information transmission step of transmitting the cushion information the input of which has been received to a second communication terminal on the side of an order receiver; a cushion information reception step of receiving the transmitted cushion information by the second communication terminal; and a mattress cover model number determination step of determining the model number of the mattress cover based on the received cushion information and the cushion information includes at least information of the shape of the cushion member in each of the partitions. In the present method, even when a mattress which includes cushion members of different shapes is ordered, it is possible to prevent an ordering error in which a mattress cover does not fit properly.

### Advantages of the Invention

In the mattress according to the present invention, a vibration is unlikely to be transmitted between different cushion members. In the method for receiving an order for a mattress according to the present invention, convenience when the mattress having the effects described above is ordered is enhanced.

### BRIEF DESCRIPTION OF DRAWINGS

FIG. 1 is a perspective view of a mattress according to a first embodiment;

FIG. 2 is an exploded perspective view of a mattress cover in FIG. 1;

FIG. 3 is an exploded perspective view of a mattress cushion contained in the mattress shown in FIG. 1;

FIG. 4 is a schematic configuration diagram of a cut surface smoothing device;

FIG. 5 is an external view of a cut surface FL1 before being smoothed;

FIG. 6 is an external view of the cut surface FL1 which has been smoothed;

FIG. 7 is a conceptual diagram showing an example of a processing method for smoothing a cut surface of cushion members;

FIG. 8 is a conceptual diagram showing a state where the mattress according to the first embodiment is used;

FIG. 9 is a conceptual diagram showing a state where a vibration is blocked when the mattress according to the first embodiment is used;

FIG. 10 is a conceptual diagram showing an example of a processing method for smoothing a cut surface of cushion members;

FIG. 11 is a conceptual diagram showing a state where a mattress according to a second embodiment is used;

FIG. 12 is a conceptual diagram showing a state where a vibration is blocked when the mattress according to the second embodiment is used;

FIG. 13 is a perspective view of a mattress according to a third embodiment;

FIG. 14 is a plan view of the mattress according to the third embodiment;

FIG. 15 is a perspective view of a mattress according to a variation of the third embodiment;

FIG. 16 is a perspective view of shapes of cushion members which can be used in an application example of the mattress according to the third embodiment;

FIG. 17 shows a specific application example of the mattress according to the third embodiment, and is a conceptual diagram when viewed from the front side (in the direction of a head);

FIG. 18 is a conceptual diagram when the specific example of the application of the mattress shown in FIG. 17 is viewed from the right side (rightward direction);

FIG. 19 is a conceptual diagram of cushion members in which electronic components having a communication function are contained;

FIG. 20 is a block configuration diagram showing an example of the configuration of a mattress system;

FIG. 21 is a block configuration diagram showing an order reception system;

FIG. 22 is a flowchart for mattress provision process;

FIG. 23 is a diagram showing an example of partition position numbers which are used when the mattress according to the third embodiment is ordered;

FIG. 24 is a diagram showing an example of a mattress order form which is used when the mattress according to the third embodiment is ordered;

FIG. 25 is an illustrative diagram of the arrangement of partitions when the shape of the partitions is mainly rhombic;

FIG. 26 is an illustrative diagram of the arrangement of partitions when the shape of the partitions is mainly equilateral triangular;

FIG. 27 is an illustrative diagram of the arrangement of partitions when the shape of the partitions is mainly equilateral triangular;

FIG. 28 is an illustrative diagram of the arrangement of partitions when the shape of the partitions is mainly regular hexagonal;

FIG. 29 is an illustrative diagram of the arrangement of partitions when the shape of the partitions is mainly regular hexagonal;

FIG. 30 is a conceptual diagram showing a state where a mattress in a conventional example is used;

FIG. 31 is a conceptual diagram showing the state where the mattress in the conventional example is used; and

FIG. 32 is a diagram for illustrating transmission of a vibration in the mattress in the conventional example.

### DESCRIPTION OF EMBODIMENTS

Hereinafter, illustrative embodiments of the present invention will be described with reference to drawings.

### 1. First Embodiment

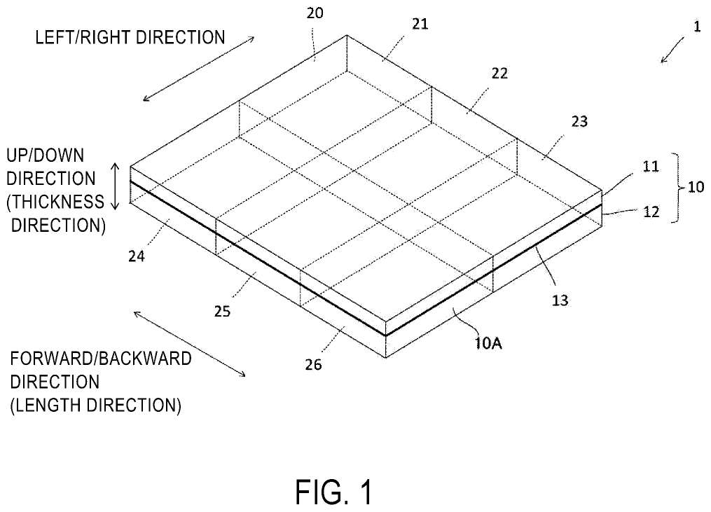

A first embodiment will first be described. FIG. 1 is a perspective view of a mattress 1 according to the first embodiment. In the mattress 1, an up/down direction, a left/right direction and a forward/backward direction are as shown in FIG. 1. In FIG. 1, for ease of understanding of the internal configuration of the mattress 1, approximate positions of cushion members 21 to 26 are indicated by dashed lines.

The mattress 1 includes a mattress cover 10 which covers the entire outer surface thereof and a mattress cushion 20 which is contained therein. The mattress 1 as a whole is in the shape of a rectangular parallelepiped which has sides in the forward/backward direction (length direction), in the left/right direction and in the up/down direction (thickness direction), a dimension in the left/right direction is slightly smaller than a dimension in the forward/backward direction and a dimension in the up/down direction is sufficiently smaller than a dimension in the left/right direction.

The mattress cushion 20 includes a total of six cushion members 21 to 26 which are obtained by dividing the mattress cushion 20 into two parts in the left/right direction and dividing the mattress cushion 20 into three parts in the length direction and which are formed with filament three-dimensional bonded members.

The mattress 1 according to the first embodiment is generally placed on a horizontal floor, a bed or the like, and is used with two users lying side by side in the left/right direction on the upper side of the mattress 1. When the mattress 1 is used in this way, the up/down direction of the mattress 1 coincides with a vertical direction. Although the size of the mattress 1 in the forward/backward direction is caused to substantially coincide with the size in the height direction of the user, and thus the mattress 1 can be suitably used, the sizes in the forward/backward direction and in the left/right direction can be freely changed according to the preference.

The mattress cover 10 includes an upper surface side cover 11, a bottom surface side cover 12 and a fastener 13. In a state where the mattress cushion 20 is inside the upper surface side cover 11 and the bottom surface side cover 12, the upper surface side cover 11 and the bottom surface side cover 12 are combined by the fastener 13.

The fastener 13 is unlikely to be stretched as compared with the other parts of the mattress cover 10, and thus the fastener 13 plays a role in preventing the perimeter of the mattress cover 10 from being stretched (plays a role as a stretch prevention member). The fastener 13 is provided around the outer perimeter of the mattress cover 10 when viewed from above with the position (height) in the up/down direction being substantially constant.

In the present embodiment, the fastener in which a woven tape is used as the stretch prevention member is used, and the fastener is arranged over the entire part where the upper surface side cover 11 and the bottom surface side cover 12 are combined. When the fastener 13 is opened, the upper surface side cover 11 and the bottom surface side cover 12 can be completely separated.

The stretch prevention member an example of which is the fastener 13 prevents the mattress cover 10 in the length direction from being stretched to prevent the gaps of the cushion members 21 to 26 from being extended due to the stretch of the mattress cover 10. The stretch prevention member is not limited to a stretch prevention member which completely prevents the stretch of the mattress cover 10. When the stretch prevention member is pulled by a force of 100 N, the stretch thereof per 1 m needs to be 2 cm or less, and the stretch thereof per 1 m is preferably 1 cm or less.

In particular, in side surfaces (left and right side surfaces) parallel to the length direction (which generally coincides with the height direction of the user), when the stretch prevention member is pulled by a force of 100 N, the stretch thereof per 1 m is preferably 0.5 cm or less. Examples of a material which can be used as the stretch prevention member include a woven tape formed of chemical fibers and the like.

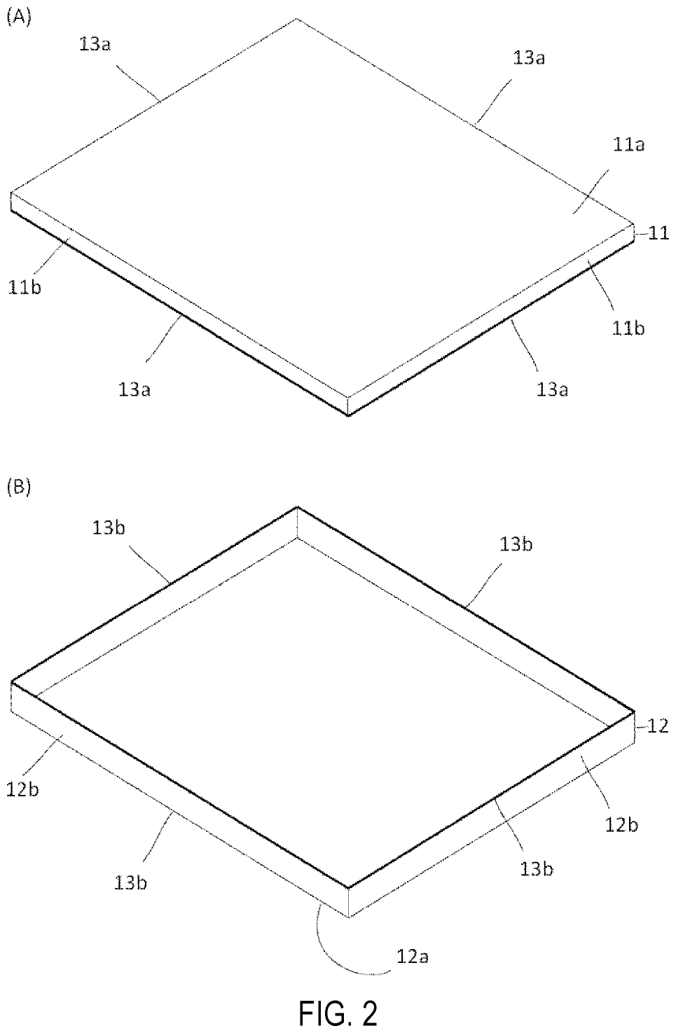

Preferably, as a position to which the stretch prevention member is attached, the stretch prevention member is continuously provided in the direction of the perimeter when viewed from above in a height position within a range of 50 to 99% of a height from a bottom surface portion 12a to an upper surface portion 11a (see FIG. 2 which will be described later) (in a position closer to the upper surface portion 11a than the center). In this case, the stretch prevention member is preferably provided to continuously surround the perimeter surface portion 10A of the mattress cover 10 including the two side surfaces (left and right side surfaces) parallel to the length direction.

Although in the present embodiment, a strip-shaped stretch prevention member is adopted, in addition to the strip-shaped stretch prevention member, for example, the entire perimeter surface portion 10A made of canvas fabric or the like may be designed to function as the stretch prevention member. In order to enhance breathability, in the perimeter surface portion 10A, a plurality of air vents or a highly breathable mesh fabric is preferably provided.

The shape of the upper surface portion 11a and the bottom surface portion 12a is not limited to the rectangle as in the present embodiment, and may be, for example, the shape of a rectangle with rounded corners. Preferably, in this case, in the perimeter surface portion 10A, the boundary parts of the front, back, left and right side surfaces (vertically extending sides) are likewise rounded.

FIG. 2 is an exploded perspective view of the mattress cover 10 in FIG. 1. More specifically, FIG. 2 is a schematic exploded perspective view when the mattress cover 10 is disassembled into the upper surface side cover 11 and the bottom surface side cover 12. The covers 11 and 12 can be combined with the fastener 13. The fastener 13 functions as the stretch prevention member as described previously.

The upper surface side cover 11 in a state shown in FIG. 2(A) includes a rectangular upper surface portion 11a which is in contact with the sleeping user and a perimeter surface portion 11b which includes four rectangular side surfaces connected to the upper surface portion 11a, and the upper surface side cover 11 as a whole is substantially in the shape of a rectangular parallelepiped which has a space thereinside. In the perimeter surface portion 11b, an upper fastener member 13a is provided.

The bottom surface side cover 12 in a state shown in FIG. 2(B) includes a rectangular bottom surface portion 12a which is in contact with a horizontal floor, a bed or the like and a perimeter surface portion 12b which includes four rectangular side surfaces connected to the bottom surface portion 12a, and the bottom surface side cover 12 as a whole is substantially in the shape of a rectangular parallelepiped which has a space thereinside. In the perimeter surface portion 12b, a lower fastener member 13b is provided. The upper fastener member 13a and the lower fastener member 13b are engaged with each other, and thus the fastener 13 in FIG. 1 is provided.

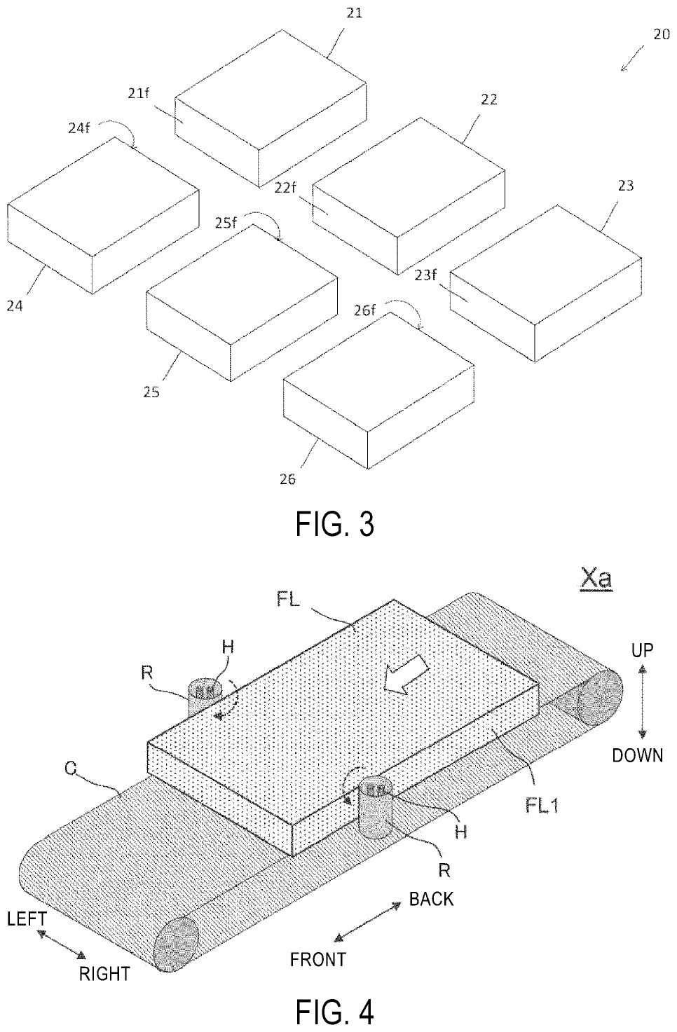

FIG. 3 is an exploded perspective view of the mattress cushion 20 contained in the mattress 1 shown in FIG. 1. The mattress cushion 20 can be divided into six cushion members 21 to 26 in the left/right direction and in the length direction. In other words, three cushion members 21 to 23 which are sequentially aligned in the length direction and three cushion members 24 to 26 which are sequentially aligned in the length direction are aligned in the left/right direction, and thus the mattress cushion 20 is formed.

The six cushion members 21 to 26 are formed with filament three-dimensional bonded members made of a resin. The filament three-dimensional bonded member is an elastic member which is obtained by three-dimensionally fusing and bonding molten filaments made of a thermoplastic resin. In the manufacturing process of the filament three-dimensional bonded member, the thermoplastic resin in a molten state is extruded downward in a vertical direction from a plurality of nozzles arranged horizontally. In this way, a molten filament having a cross-sectional diameter of around 1 mm is dropped into cooling water, thus loops are formed by the buoyancy of the water and simultaneously and a plurality of molten filaments which form the loops are fused and bonded three-dimensionally, with the result that the filament three-dimensional bonded member is obtained. Here, the thickness and the width of a molten filament group extruded from the nozzles are regulated with a chute (metal plate), a drawing machine (a roller and a conveyer) and the like, and thus a smooth surface layer can be formed in which the density of the filaments is higher in both ends in the thickness direction and both ends in the width direction than in the center in the thickness direction. As a method for manufacturing the filament three-dimensional bonded member as described above, a method discloses in Patent Document 1 or the like can be adopted.

The thickness (dimension in the up/down direction) of the filament three-dimensional bonded member is preferably in a range of 10 to 25 cm. In the filament three-dimensional bonded member, the diameter of the filament (cross-sectional diameter) is preferably in a range of 0.5 to 2 mm, and the bulk density is preferably in a range of 30 to 150 kg/m³.

When the diameter of the filament in the filament three-dimensional bonded member is less than 0.5 mm, a draining time and a drying time after washing are extended. By contrast, when the diameter of the filament exceeds 2 mm, the soft feel of the filament three-dimensional bonded member is easily lost. When the bulk density of the filament three-dimensional bonded member is less than 30 kg/m³, the filament three-dimensional bonded member itself is easily deformed in the length direction, and thus in the surface of the mattress, oval grooves and depressions easily occur. By contrast, when the bulk density exceeds 150 kg/m³, the weight of the filament three-dimensional bonded member is increased, and thus it is difficult to convey the filament three-dimensional bonded member.

The bulk density of the filament three-dimensional bonded member can be measured by, for example, a measurement method using a measurement sample in the shape of a rectangular parallelepiped. In this measurement method, the mass W (kg) of the measurement sample and sizes (m) in the directions (a vertical direction, a horizontal direction and a height direction) of the measurement sample are first measured. The sizes (m) in the directions (the vertical direction, the horizontal direction and the height direction) of the measurement sample are multiplied together, and thus the volume V (m³) of the measurement sample is calculated. The bulk density (kg/m³) is calculated by dividing the mass W (kg) of the measurement sample by the volume V (m³) of the measurement sample.

In the six cushion members 21 to 26, the smooth surface layer is formed in each of the contact surfaces of cushion members adjacent in the left/right direction, that is, in each of contact surfaces 21f and 24f of the cushion members 21 and 24, in each of contact surfaces 22f and 25f of the cushion members 22 and 25 and in each of contact surfaces 23f and 26f of the cushion members 23 and 26. This smooth surface layer is a layer 2 mm deep from the surface of the cushion member, its bulk density is higher than the inside thereof and the smooth surface layer is a layer in which the cut ends (cuts) of the filaments do not protrude outward of the surface. Each of the contact surfaces 21f to 26f is a surface which is parallel to the up/down direction (thickness direction) and is orthogonal to the left/right direction.

The smooth surface layer is formed to prevent the entrance of ends of the filaments of one of the cushion members (cut ends of the filaments and projections of loops of the filaments) into the filaments of the other cushion member, and the smooth surface layer is preferably in a state where the filaments are fused (bonded) at a high density to prevent free filaments from forming protrusions.

Examples of a method for forming the smooth surface layer include: a method (hereinafter also referred to as a “first method”) of using a chute disclosed in Patent Document 1 to manufacture a filament three-dimensional bonded member (reticular structure) and simultaneously forming a smooth surface layer in a surface layer; and a method (hereinafter also referred to as a “second method”) of forming a filament three-dimensional bonded member, then cutting it into a predetermined size, then extruding the cut surface while heating and melting the cut surface and thereby forming a smooth surface layer.

The porosity (the volume of air per unit volume) of the smooth surface layer is preferably equal to or greater than 30% and equal to or less than 85% because when the density (porosity) of the smooth surface layer is excessively lowered, the breathability (airiness) of the filament three-dimensional bonded member is impaired, and thus a repulsive force is remarkably increased. When the porosity is less than 30%, there are concerns that the breathability is lowered and the repulsive force is excessively increased. On the other hand, when the porosity exceeds 85%, there are concerns that a large number of free filaments (existing alone) are formed and thus a friction force with the adjacent cushion member is excessively increased.

The smoothness of the smooth surface layer is sufficient such that in the contact surface of the adjacent cushion members, the ends of the filaments of one of the cushion members can be prevented from entering the interior of the filaments of the other cushion member. The smoothness is also preferably obtained by pressurizing the surface layer of the filament three-dimensional bonded member with a plate and a roller while fusing the surface layer so as to cause the porosity of the smooth surface layer to fall in a range equal to or greater than 30% and equal to or less than 85%.

Although in the present embodiment, the example is shown where the smooth surface layers are formed only in the contact surfaces 21f to 26f of the cushion members adjacent in the left/right direction among all the surfaces of the cushion members 21 to 26, the smooth surface layers may be formed in all the surfaces of the cushion members 21 to 26. All the surfaces are smoothed, and thus the upper surface of the mattress cushion 20 is smooth to enhance sleeping comfort, and it is also possible to smoothly insert and remove the mattress cushion 20 into and from the mattress cover 10.

By the first method described previously, it is possible to manufacture the filament three-dimensional bonded member and to simultaneously form the smooth surface layer in the surface layer. On the other hand, in the cut surface generated by cutting the manufactured filament three-dimensional bonded member, the smooth surface layer can be formed by the second method.

As a device which can form the smooth surface layer by the second method, for example, a cut surface smoothing device Xa shown in FIG. 4 is mentioned. The cut surface smoothing device Xa is a device which smooths the cut surface FL1 of the filament three-dimensional bonded member FL that has been cut into a predetermined size in the previous step.

As shown in the figure, rollers R are provided on both left and right sides of a conveyer C so as to be opposite each other in the left/right direction, and are rotatably installed with its center axis extending in the up/down direction used as a rotation axis. The rollers R are arranged such that the outer surface of one of the left and right rollers R is in contact with the cut surface FL1 of the filament three-dimensional bonded member FL conveyed by the conveyer C and the outer surface of the other roller R is in contact with the other cut surface FL1. The distance between the outer surfaces of the rollers R is set slightly smaller than the distance between the cut surfaces FL1 of the filament three-dimensional bonded member FL.

In each of the rollers R, a heater H for heating the roller R is arranged. As the heater H, for example, a halogen heater is adopted, and the roller R is heated such that at least the temperature of the outer surface of the roller R is equal to or higher than the melting point of the filament three-dimensional bonded member FL. The specific form of the heater H is not particularly limited as long as the specific form does not depart from the spirit of the present invention, and for example, a heater which outputs hot air or a heater which uses IH (Induction Heating) may be used. As the heater H, a heater which heats the roller R from the outside of the roller R may be used.

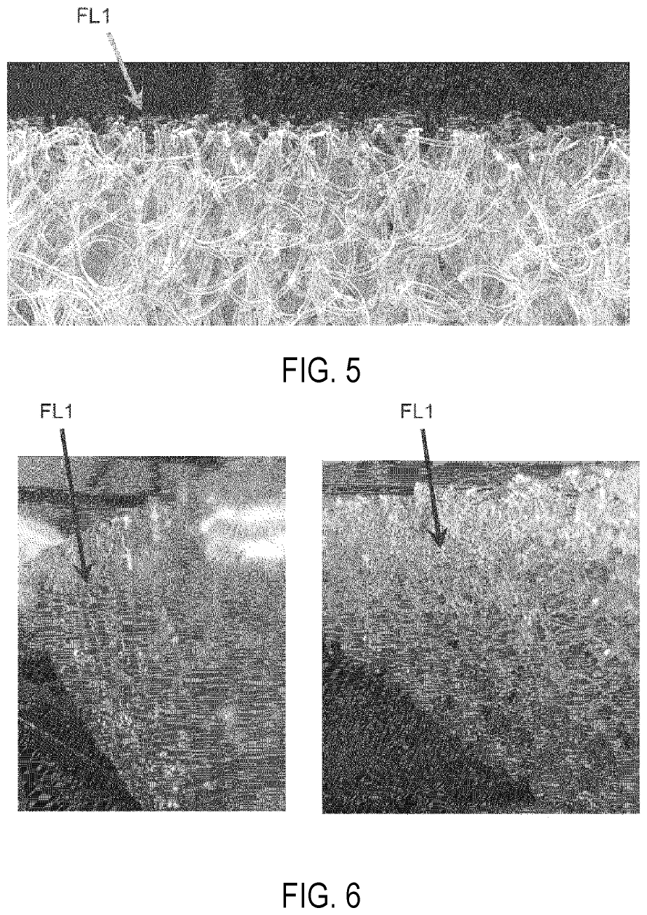

When the filament three-dimensional bonded member FL conveyed by the conveyer C passes through a position sandwiched between the rollers R, the rollers R receive forces from the cut surfaces FL1 to rotate in directions indicated by dashed lines with arrows in FIG. 5. In other words, the rollers R are rotated in the same direction as the direction of the conveyance of the conveyer C while being applied to the cut surfaces FL1 (that is, the rollers R are rotated such that the direction of travel at a contact point is the same). A drive device such as a motor which drives the rollers R to rotate may be provided, and thus the drive device may rotate the rollers R according to the speed of the conveyance of the filament three-dimensional bonded member FL.

Since the distance between the outer surfaces of the rollers R is slightly smaller than the distance between the cut surfaces FL1 of the filament three-dimensional bonded member FL, the cut surfaces FL1 travel in the direction of the conveyance while being slightly pressed by the rollers R. Here, the temperature of each of the outer surfaces of the rollers R is equal to or higher than the melting point of the filament three-dimensional bonded member FL, and thus the cut surfaces FL1 are smoothed. When the entire filament three-dimensional bonded member FL has passed through the position sandwiched between the rollers R, the entire cut surfaces FL1 have been smoothed. In this way, it is possible to obtain the filament three-dimensional bonded member FL in which the cut surfaces FL1 on both left and right sides are smoothed.

Here, FIG. 5 shows an example of the external view (photograph) of the cut surface FL1 before being smoothed, and FIG. 6 shows an example of the external view (photograph) of the cut surface FL which has been smoothed. FIG. 5 shows a diagram which is viewed in a direction substantially perpendicular to the cut surface FL1. FIG. 6 shows diagrams which are viewed in slightly different directions.

As shown in FIG. 5, the cut surface FL1 before being smoothed is remarkably nonuniform, and in particular, the loop shapes of the filaments of the filament three-dimensional bonded member FL are cut by a cutter, with the result that the ends of the filaments are often exposed. On the other hand, in the cut surface FL1 shown in FIG. 6, the exposed ends of the filaments and the like are molten and are then pressed by the rollers R, and thus they are fused to filaments in the vicinity thereof or are deformed in the direction of the pressing, with the result that the cut surface FL1 is smoothed as compared with the cut surface FL1 shown in FIG. 5. In the cut surface FL1, the entire filaments are pressed by the rollers R in a state where the filaments are heated and fused so as to be smoothed. In this way, the formation of the smooth surface layer by the second method is achieved.

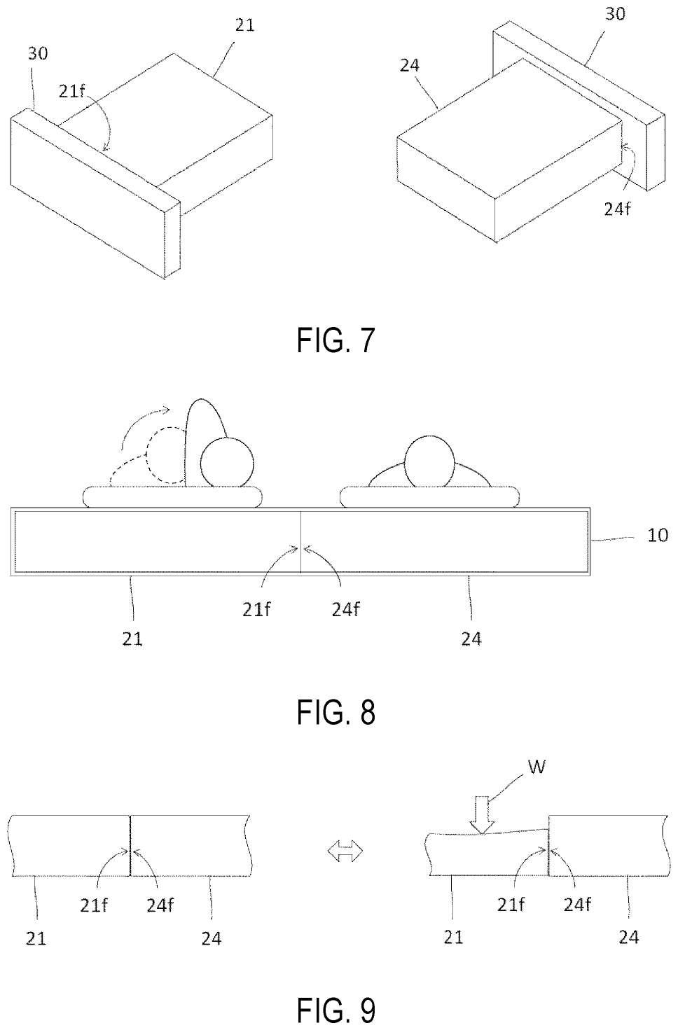

A specific method for forming the smooth surface layer by the second method is not limited to the method using the rollers as described above, and for example, as shown in FIG. 7, a heated flat plate 30 may be pressed in a direction perpendicular to the cut surface (for example, the contact surfaces 21f and 24f) of the filament three-dimensional bonded member (for example, the cushion members 21 and 24) so as to form a smooth surface in the cut surface. As a means for heating the flat plate 30, in addition to use of a halogen heater, high frequency induction heating (IH) which performs heating by utilization of electromagnetic induction, and an ultrasonic plastic welder (made by ULTRASONIC ENGINEERING CO., LTD.) which generates heat at an interface by applying an ultrasonic vibration to a thermoplastic resin may be used. Although the second method is illustrated as a method for reducing the contact friction force on the cut surface serving as the contact surface, the method is not limited to the second method as long as the method can reduce the contact friction force on the cut surface.

As a cutting device for cutting the filament three-dimensional bonded member with a cutter, a high-speed cutting machine such as a circular saw is mentioned. However, since the filament three-dimensional bonded member has a high porosity (80 to 90%), and the diameter of each of the filaments is so flexible as to be around 1 mm, if the filaments receive a compressive force or an impact force from rotating teeth when the filament three-dimensional bonded member is cut, the filaments are easily deformed in a direction in which the filaments are moved away from the rotating teeth, with the result that the filaments are cut in a state where the filaments are deformed in the direction in which the filaments are moved away from the rotating teeth.

Although the filaments which are cut in the state where the filaments are deformed are returned to a state before the deformation when the compressive force or the impact force caused by the rotating teeth is removed, the returning distance is different depending on each of the filaments, with the result that an uneven cut surface is provided. Consequently, when a virtual plane formed by connecting cut points of the filaments is regarded as the cut surface of the filament three-dimensional bonded member, recesses and projections of about 5 to 10 mm are generated in the cut surface. When the recesses and projections exceed 5 mm, cut ends of some filaments in the cut surface of the filament three-dimensional bonded member enter the interior of the filament three-dimensional bonded member adjacent thereto, and thus an engagement force is generated, with the result that the contact friction force is increased.

In view of the problem described above, examples of another method (third method) for reducing recesses and projections (contact friction force) in the cut surface include: a method of cutting the filament three-dimensional bonded member with a circular saw in a state where the temperature of the filament three-dimensional bonded member is lowered until the resilience thereof is decreased; and a method of cutting the filament three-dimensional bonded member with a circular saw in a state where the filament three-dimensional bonded member is compressed in the thickness direction (in a state where the filaments are unlikely to be moved when the filament three-dimensional bonded member is cut). Another method is a method of cutting the filament three-dimensional bonded member by increasing the circumferential speed of the rotating teeth of a circular saw when the filament three-dimensional bonded member is cut with the circular saw. In this case, the circumferential speed of the rotating teeth is preferably set equal to or greater than 50 m/sec. Another method is a method of cutting the filament three-dimensional bonded member by decreasing a compressive force applied to the filament three-dimensional bonded member from rotating teeth when the filament three-dimensional bonded member is cut with a circular saw so as to decrease the amount of deformation of the filament three-dimensional bonded member.

When the filament three-dimensional bonded member whose repulsive force is equal to or greater than 100 N and equal to or less than 200 N is used, a force which is applied to the filament three-dimensional bonded member from tips of the teeth is preferably equal to or less than 100N, and a pressure which is applied to the filament three-dimensional bonded member from the rotating teeth is preferably set equal to or less than 5000000 pascals. In this way, the amplitude of a vibration caused in one of the adjacent filament three-dimensional bonded members is decreased in the contact surface, and thus the vibration is unlikely to be transmitted to the other filament three-dimensional bonded member. The smoothness index of the cut surface is preferably equal to or greater than 0 mm and equal to or less than 3 mm, and further preferably equal to or greater than 0 mm and equal to or less than 1 mm.

In the invention of the present application, the smoothness index of the cut surface of the cushion member can be measured by the following method. Two metal plates α in which a plurality of metal needles having a length of 5 mm are fixed to the surface at intervals of 5 cm are used, and thus the cushion member is brought into a state where the cushion member is sandwiched in the thickness direction (direction parallel to the cut surface) to be fixed (into a state where the metal needles of the metal plates α are stuck into the cushion members). In this state, a metal plate β which has a pressing surface with the same shape and area as the cut surface is arranged opposite the cut surface, and the metal plate β is moved in parallel toward the cut surface. In this way, the movement distance of the metal plate β from a time when the cut surface is pressed such that a pressure of 100 Pa is applied to the cut surface in a vertical direction until a time when the cut surface is pressed such that a pressure of 500 Pa is applied in the same direction is measured, and the measured movement distance is assumed to be the smoothness index. There is a tendency that as a smaller number of filaments protrude outward in the cut surface, and the length of the filaments is shorter, the smoothness index of the cut surface is decreased, and the degree of smoothness of the cut surface is said to be high. In order to reduce the contact friction force on the cut surface, a cover for covering the cut surface may be provided. By reducing the contact friction force on the cut surface, it is easy to insert and remove the mattress cushion into and from the mattress cover.

FIG. 8 is a conceptual diagram showing a state where the mattress 1 according to the first embodiment is used. FIG. 9 is a conceptual diagram showing a state where a vibration is blocked when the mattress 1 according to the first embodiment is used. In FIG. 9, the cushion member 21 and the cushion member 24 are adjacent to each other, and FIG. 9 shows, on the right side, a state where a load W is applied to the cushion member 21, and shows, on the left side, a state where the load W is not applied.

Although the user on the left side of FIG. 8 turns over to generate an up and down movement (vibration) in the cushion member 21, the contact surface 21f of the cushion member 21 and the contact surface 24f of the cushion member 24 are smoothed, and thus the friction force (engagement force) is lowered, with the result that the transmission of the up and down movement (vibration) to the cushion member 24 is suppressed. Consequently, an effect is obtained in which the vibration is unlikely to be transmitted to the user on the right side. Likewise, a vibration caused by the turning over of the user on the right side is unlikely to be transmitted to the user on the left side.

As described above, the mattress 1 includes the mattress cushion 20 on which a plurality of persons can lie in the left/right direction, and the mattress cushion 20 includes a plurality of cushion members 21 to 26 which can be separated in the left/right direction. In the mattress 1, each of the cushion members 21 to 26 is formed with the filament three-dimensional bonded member which includes a plurality of filaments, and includes the contact surfaces 21f to 26f which are in contact with the other cushion members adjacent to the cushion member. Furthermore, in the mattress 1, ends of the filaments of each of the cushion members 21 to 26 (cut ends of the filaments and projections of loops of the filaments) do not enter the other cushion member adjacent to the cushion member (in other words, do not enter the inside of the contact surface of the other cushion member adjacent to the cushion member).

Hence, in the mattress 1, in the contact surfaces 21f to 26f of the cushion members adjacent in the left/right direction, the contact friction force generated by the entrance of ends of the filaments of one of the cushion members into the filaments of the other cushion member can be reduced, with the result that it is possible to suppress the transmission of the vibration caused by the turning over of one of the users to the other user. In the mattress 1, the ends of the filaments of each of the cushion members 21 to 26 do not protrude outward of the contact surfaces in all regions of the contact surfaces 21f to 26f. Therefore, the entrance of the ends of the filaments into the other adjacent cushion member is reliably prevented.

Preferably, in the mattress 1, the repulsive force of each of the cushion members 21 to 26 is equal to or greater than 100 N and equal to or less than 200 N, and the contact friction force on each of the contact surfaces 21f to 26f between the cushion members adjacent to each other is greater than 0 N and less than 50 N. In this way, since the contact friction force is less than 50 N, the cushion member in which the repulsive force is equal to or greater than 100 N and equal to or less than 200 N is used, and thus the amplitude of the vibration in the contact surface is significantly reduced. Hence, it is possible to further suppress the transmission of the vibration caused by the turning over of one of the users to the other user.

Each of the cushion members 21 to 26 includes the smooth surface layer in each of the contact surfaces 21f to 26f. Hence, since the cut ends (cuts) of the filaments are not present in the contact surfaces 21f to 26f, not only a static contact friction force but also a dynamic contact friction force can be reduced, with the result that even when a vibration with a large amplitude is generated, the vibration is unlikely to be transmitted on the contact surfaces 21f to 26f.

### 2. Second Embodiment

A second embodiment will then be described. The second embodiment is basically the same as the first embodiment except that recesses which will be described later are formed in the contact surfaces 21f to 26f of the cushion members 21 to 26. In the second embodiment, a cushion member corresponding to the cushion member 21 in the first embodiment is assumed to be a cushion member 121, and a cushion member corresponding to the cushion member 24 in the first embodiment is assumed to be a cushion member 124.

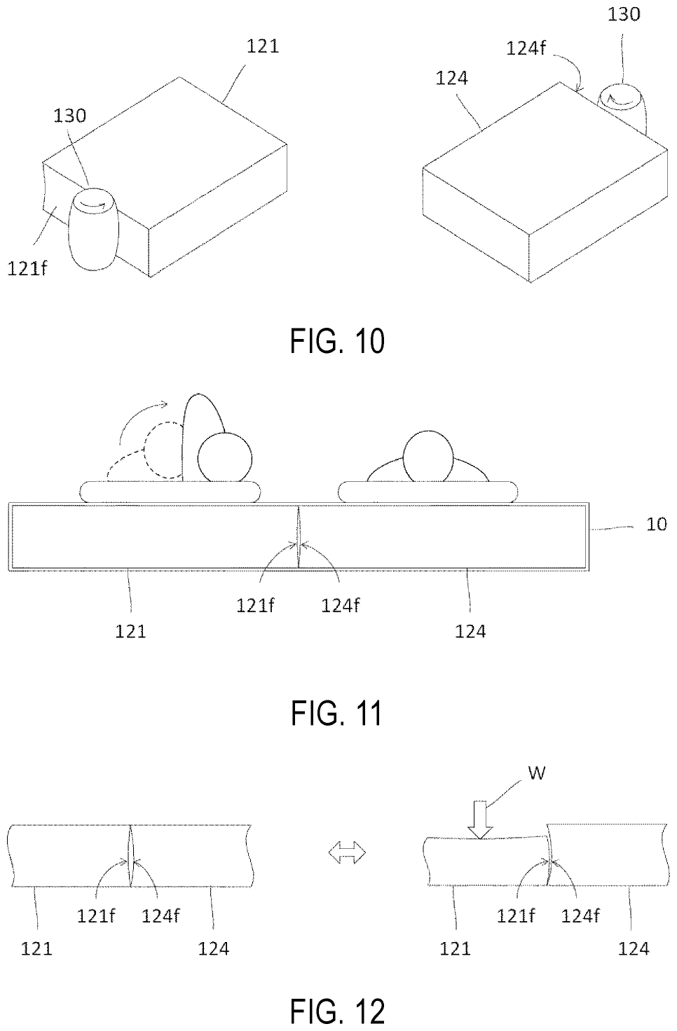

FIG. 10 shows an example of a method which is one of methods for forming the smooth surface layer by the second method and is adopted in the second embodiment. Although FIG. 10 shows a state where the two cushion members 121 and 124 are processed, the same processing is performed on the remaining four cushion members (cushion members corresponding to the cushion members 22, 23, 25 and 26 in the first embodiment).

As shown in FIG. 10, the cut surfaces (contact surfaces 121f and 123f) of the cushion members 121 and 124 are pressed by a heated roller 130. In this way, the cut surfaces are pressed by the roller 130 in a state where the entire filaments are heated and fused, and thus the cut surfaces are smoothed, and simultaneously, the density thereof is increased, with the result that the smooth surface layer is formed.

In the roller 130, a crown is formed in the surface of the roller in contact with the cut surface. In other words, the diameter of the roller 130 relative to the rotation axis of the roller 130 is increased toward the inside from both ends of the roller 130 in the direction of the rotation axis. For example, a method for heating the roller 130 may be the same as the method for heating the flat plate 30 described previously. The cut surface is pressed by the surface of the roller including such a crown, and thus the recess which is recessed inward can be formed in the cut surface.

FIG. 11 is a conceptual diagram showing a state where the cushion members 121 and 124 in the second embodiment are used, and FIG. 12 is a conceptual diagram showing a state where a vibration is blocked when the cushion members 121 and 124 in the second embodiment are used. In FIG. 12, the cushion member 121 and the cushion member 124 are adjacent to each other, and FIG. 12 shows, on the right side, a state where a load W is applied to the cushion member 121, and shows, on the left side, a state where the load W is not applied.

Although the user on the left side of FIG. 11 turns over to generate an up and down movement (vibration) in the cushion member 121, the contact surface 121f of the cushion member 121 and the contact surface 124f of the cushion member 124 are smoothed in a recessed shape, and thus the friction force (engagement force) almost disappears, with the result that the transmission of the up and down movement (vibration) to the cushion member 124 is minimized. Consequently, the effect is obtained in which the vibration is unlikely to be transmitted to the user on the right side. Likewise, the vibration caused by the turning over of the user on the right side is unlikely to be transmitted to the user on the left side.

### 3. Third Embodiment

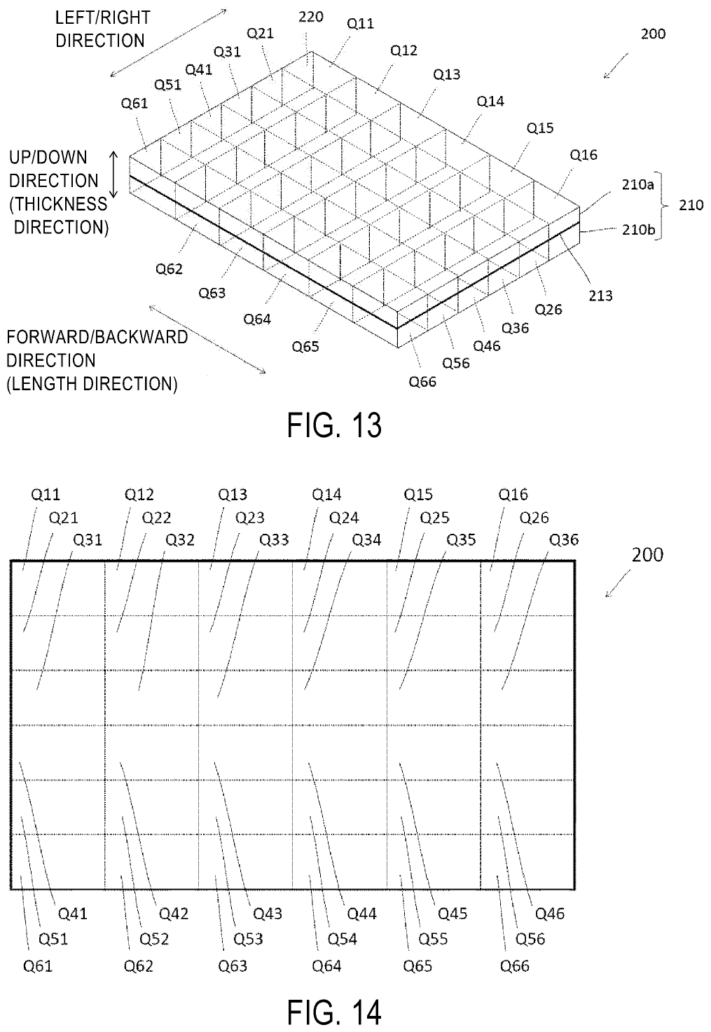

FIG. 13 is a perspective view of a mattress 200 according to a third embodiment. FIG. 14 is a plan view of the mattress 200. In the mattress 200, an up/down direction, a left/right direction and a forward/backward direction are as shown in FIG. 13. In FIGS. 13 and 14, for ease of understanding of the internal configuration of the mattress 200, approximate positions of cushion members Q11 to Q66 are indicated by dashed lines.

The mattress 200 includes a mattress cover 210 which covers the entire outer surface thereof and a mattress cushion 220 which is contained therein and is formed with a filament three-dimensional bonded member. The mattress 200 as a whole is in the shape of a rectangular parallelepiped which has sides in the forward/backward direction (length direction), in the left/right direction and in the up/down direction (thickness direction), a dimension in the left/right direction is slightly smaller than a dimension in the forward/backward direction and a dimension in the up/down direction is sufficiently smaller than a dimension in the left/right direction.

The mattress cushion 220 includes a total of 36 cushion members Q11 to Q66 which are obtained by dividing the mattress cushion 220 into six parts in the left/right direction and dividing the mattress cushion 220 into six parts in the length direction. Although the mattress cushion 220 has such a size that a plurality of persons can lie side by side in the left/right direction, the mattress cushion 220 can be used with one person lying thereon.

Each of the 36 cushion members Q11 to Q66 is in the shape of a rectangular parallelepiped, and smooth surface layers are formed in all the outer surfaces of the cushion members Q11 to Q66. In this way, the cushion members Q11 to Q66 are smoothly inserted and removed into and from the mattress cover 210, the influence of friction with adjacent cushion members can be suppressed and thus an independent up and down movement can be made. In the cushion members Q11 to Q66, the smooth surface layers may be formed only in contact surfaces with adjacent cushion members.

The mattress cover 210 includes an upper surface side cover 210a, a bottom surface side cover 210b and a fastener 213. In a state where the mattress cushion 220 is inside the upper surface side cover 210a and the bottom surface side cover 210b, the upper surface side cover 210a and the bottom surface side cover 210b are combined by the fastener 213.

The fastener 213 is unlikely to be stretched as compared with the other parts of the mattress cover 210, and thus the fastener 213 plays a role in preventing the perimeter of the mattress cover 210 from being stretched (plays a role as a stretch prevention member). The fastener 213 is provided around the outer perimeter of the mattress cover 210 when viewed from above with the position (height) in the up/down direction being substantially constant.

Although in the mattress 200, the cushion members Q11 to Q66 in the same shape of the rectangular parallelepiped are contained in the mattress cover 210, as an application example of the mattress 200, two or more types of cushion members in which at least one of the repulsive force and the shape are different can be used. In this way, the cushion members of the mattress can easily be changed according to the position of the bed, an environment in which the bed is used, the physical condition of the user or a function which the user wants to utilize, and thus it is possible to provide a comfortable sleeping environment under a variety of changing conditions. The details of the application example will be described later.

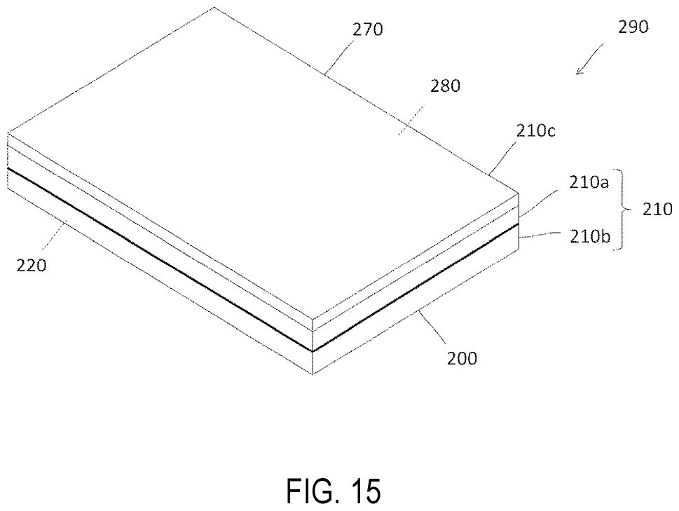

FIG. 15 is a perspective view of a mattress 290 according to a variation of the third embodiment. The mattress 290 has a structure in which an overlay mattress 270 is placed on the upper surface of the mattress 200 shown in FIG. 13. The overlay mattress 270 includes a mattress cover 210C which covers the entire outer surface thereof and a mattress cushion 280 which is contained therein and is formed with one sheet of filament three-dimensional bonded member.

The overlay mattress 270 is placed to be able to suppress the falling of a part of the body into a gap between adjacent cushion members. The thickness of the mattress cushion 280 is preferably equal to or greater than 10 mm and equal to or less than 50 mm. When the thickness is less than 10 mm, it is difficult to obtain the falling prevention effect whereas when the thickness exceeds 50 mm, it is difficult to obtain the effect of dividing the cushion members of the mattress 200.

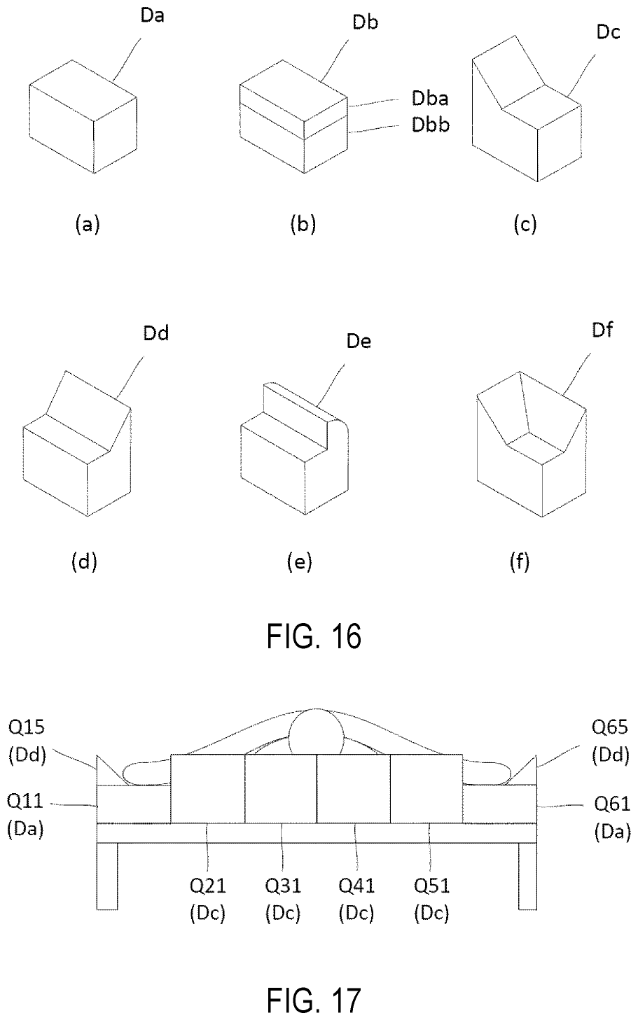

FIG. 16 is a perspective view showing shapes of cushion members which can be used as the application example of the mattress 200 according to the third embodiment. As the cushion members Q11 to Q66 of the mattress 200, various types of cushion members shown in FIG. 16 can be arbitrarily selected and used.

FIG. 16 (a) shows a cushion member Da in the shape of a rectangular parallelepiped. A plurality of types of cushion members Da which have different repulsive forces are previously prepared, and thus it is possible to select cushion members having repulsive forces suitable for parts of the body.

FIG. 16 (b) shows a cushion member Db in the shape of a rectangular parallelepiped which has a two-layer structure. In the cushion member Db, a highly resilient upper cushion member Dba and an ultra-high resilient lower cushion member Dbb are vertically arranged, and thus the cushion member Db can be utilized without loss of body pressure dispersion as a cushion member for sitting on an edge which has an extremely high repulsive force and does not excessively sink even when the user sits on the mattress.

FIG. 16 (c) shows a cushion member Dc in the shape of a rectangular parallelepiped in which the height of an end in the forward/backward direction is increased. Even when a head board is not provided in the bed, the cushion member Dc is arranged at a front end of the mattress cushion 220 in the forward/backward direction, and thus an effect of preventing a pillow from slipping down is obtained.

FIG. 16 (d) shows a cushion member Dd in the shape of a rectangular parallelepiped in which the height of an end in the left/right direction is increased. Even when a handrail, a wall or the like is not provided on the side of the bed, the cushion member Dd is arranged at an end of the mattress cushion 220 in the left/right direction, and thus an effect of preventing a comforter from slipping down is obtained.

FIG. 16 (e) shows a cushion member De (variation of the cushion member Dd) in the shape of a rectangular parallelepiped in which the height of an end in the left/right direction is increased. In the cushion member De, the inclination angle of a part whose height is increased relative to a part whose height is not increased is 90 degrees, and simultaneously, the corner of the part whose height is increased is rounded. In this way, the cushion member De is used, and thus an effect of preventing a comforter from slipping down is obtained, and the comforter which has slipped down can easily be lifted up.

FIG. 16 (f) shows a cushion member Df in the shape of a rectangular parallelepiped in which the heights of ends in the forward/backward direction and in the left/right direction are increased. The cushion member Df is provided at a corner on the side of a mattress head (front end of the mattress cushion 220), and thus the cushion member Df can be utilized as a storage space for a small item needed at bedtime such as a smartphone, a medicine or a watch.

Regardless of the cushion member Df, even in another cushion member, a recess (holder) in which a smartphone or a PET bottle can be stored may be formed in the upper surface of the cushion member so that the smartphone, a drink in the PET bottle or the like is prevented from falling or tipping over.

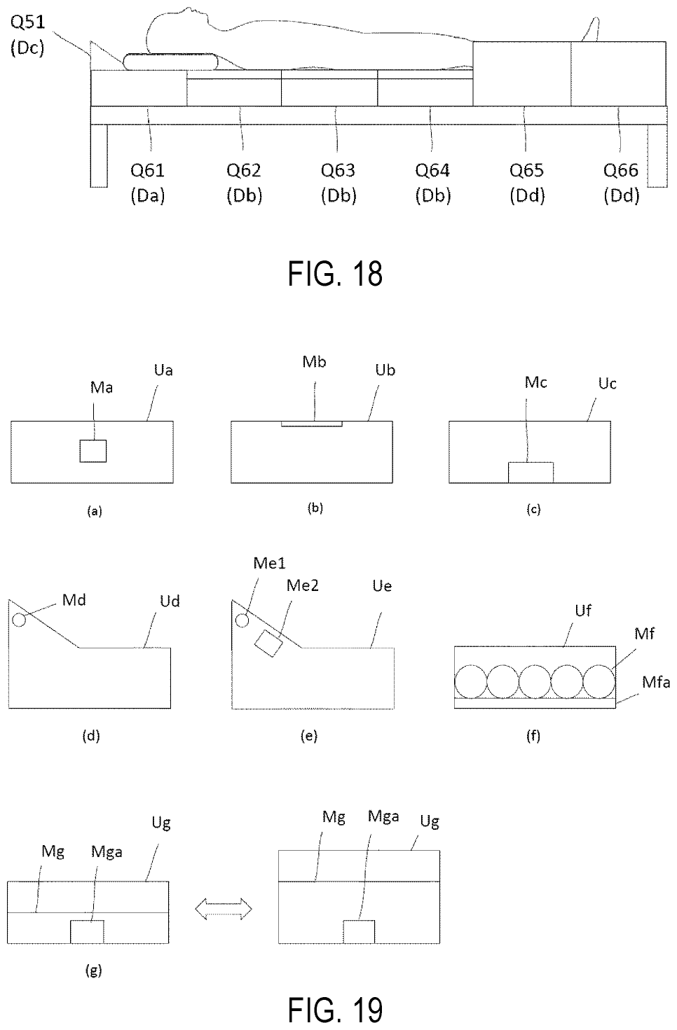

FIG. 17 shows a specific application example of the mattress 200 according to the third embodiment, and is a conceptual diagram when viewed from the front side (in the direction of the head), and FIG. 18 is a conceptual diagram when the specific application example of the mattress 200 shown in FIG. 17 is viewed from the right side (in a rightward direction). In the mattress shown in FIGS. 17 and 18, the provision of the overlay mattress 270 is omitted, and the mattress cover 210 suitable for the shape of the mattress cushion 220 is adopted.

In the mattress shown in FIGS. 17 and 18, the four cushion members Q21, Q31, Q41 and Q51 shown in FIG. 13 are replaced from the cushion members Da in the shape of a rectangular parallelepiped with the cushion members Dc (FIG. 16 (c)) in the shape of a rectangular parallelepiped in which the height of an end in the forward/backward direction is increased; the three cushion members Q62 to Q64 and the three cushion members Q12 to Q14 are replaced from the cushion members Da in the shape of a rectangular parallelepiped with the cushion members Db (FIG. 16 (b)) in the shape of a rectangular parallelepiped which has a two-layer structure; and the two cushion members Q65 and Q66 and the two cushion members Q15 and Q16 are replaced from the cushion members Da in the shape of a rectangular parallelepiped with the cushion members Dd (FIG. 16 (d)) in the shape of a rectangular parallelepiped in which the height of an end in the left/right direction is increased.

FIG. 19 is a conceptual diagram of cushion members which can be used as another application example of the mattress 200 according to the third embodiment, in which electronic components (hereinafter also referred to as IoT modules) having a communication function are contained and which are formed with filament three-dimensional bonded members. The various types of cushion members shown in FIG. 19 can be arbitrarily selected and used as the cushion members Q11 to Q66 of the mattress 200. The cushion members shown in FIG. 19 may be combined as necessary with the configurations of the cushion members previously shown in FIG. 16.

The IoT module contained in the cushion member includes a communication device, an electronic device which is connected to the communication device and an internal battery. In the IoT module, electrical wiring for supplying power from the outside may be provided as necessary.

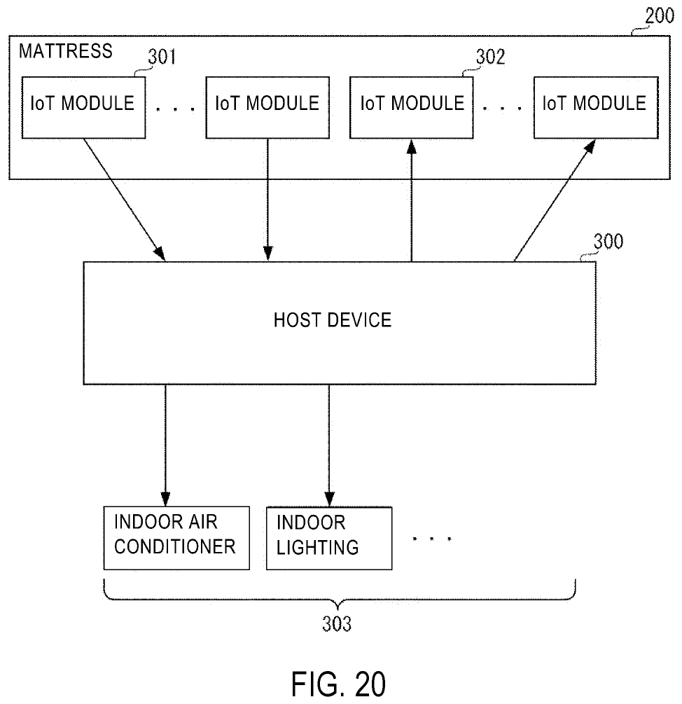

Examples of the communication device included in the IoT module include near-field wireless communication devices for Wi-fi, Bluetooth, NFC and the like. The near-field wireless communication device is connected to a communication device (hereinafter also simply referred to as a host device), such as a smartphone, which serves as a host, and transmits and receives necessary data. FIG. 20 shows an example of the configuration of a mattress system which includes the IoT modules and the host device 300.

As the electronic devices included in the IoT module, for example, information collection devices such as a temperature/humidity sensor, an acceleration sensor, a touch sensor, a switch, a microphone and the like are adopted. The IoT module 301 which includes the information collection device as described above transmits collected information to the host device 300 as shown in FIG. 20.

As the electronic devices included in the IoT modules, for example, function providing devices are adopted such as an LED lighting, a fan, a speaker, a heater, a humidifier, a thermal shutter, a sterilizing ion generator, an aroma generator, a massage vibrator, a body pillow airbag, a calf lifting airbag, a bedsore patient airbag, a bedsore patient prevention posture change airbag and an alarm up and down movement airbag. As shown in FIG. 20, the IoT module 302 which includes the function providing device as described above receives data from the host device 300 with the communication device, and drives the function providing device based on the received data. In other words, the function providing device is also said to be a driven device which is driven based on the data received by the communication device.

As a bedsore patient mattress, a bedsore patient air mattress that includes a plurality of airbags (which may also be referred to as air cells) in which pressure can be individually controlled has been conventionally used. Since the cause of the occurrence and worsening of bedsore is that a bedsore patient who cannot turn over in bed suffer from poor blood circulation caused by prolonged pressure of the mattress on a specific protruding part such as a bone of the patient, in order to relieve the prolonged pressure, the pressure of each airbag is varied at intervals of about 10 minutes to prevent high pressure from being applied to the specific part for a long period of time.

However, in the conventional bedsore patient air mattress, since the airbags are easily deformed, when the internal pressure of an airbag is lower than the internal pressure of an adjacent airbag, the contact area between the airbag with the lower internal pressure and the bedsore patient is decreased whereas the contact area between the adjacent airbag with the higher internal pressure and the bedsore patient is increased. Consequently, a problem occurs in that in the vicinity of the boundary of the airbags, an area where pressure is constantly high is generated. In this respect, as in the invention of the present application, the filament three-dimensional bonded member is provided in an upper portion of an airbag, and thus the contact area with the bedsore patient is not changed, with the result that the pressure distribution becomes sharper.

Inside one cushion member, a plurality of electronic devices may be included or both the IoT module 301 including the information collection device and the IoT module 302 including the function providing device may be included. As shown in FIG. 20, outside the mattress 200, external IoT modules 303 such as an indoor air conditioner and an indoor lighting are provided, and the external IoT modules 303 are controlled by the host device 300.

FIG. 19 (a) shows a cushion member Ua in the shape of a rectangular parallelepiped which includes a temperature/humidity sensor Ma (IoT module 301) having a communication function thereinside. The temperature/humidity sensor Ma measures the temperature and humidity inside the mattress, and transmits data to the host device 300 such as a smartphone. The host device 300 transmits data to the external IoT modules 303 such the indoor air conditioner by a preset procedure, and thereby can control the external IoT modules 303.

FIG. 19 (b) shows a cushion member Ub in the shape of a rectangular parallelepiped which includes a touch sensor Mb (IoT module 301) having a communication function thereinside. Even in a dark bedroom, the user only touches the touch sensor Mb, and thus the touch sensor Mb can transmit data (user's indication of intention) to the host device 300. The host device 300 receiving the data transmits, by a preset procedure, data to the IoT module 302 having the function providing device of a blower fan and the external IoT module 303 such as the indoor lighting, and thereby can operate the IoT module 302 and the external IoT module 303.

FIG. 19 (c) shows a cushion member Uc in the shape of a rectangular parallelepiped which includes a blower fan Mc (IoT module 302) having a communication function thereinside. The rotation speed of the blower fan Mc is controlled according to data transmitted from the host device 300.

FIG. 19 (d) shows a cushion member Ud which includes an acceleration sensor Md (IoT module 301) having a communication function thereinside and is in the shape of a rectangular parallelepiped and in which the height of an end in the forward/backward direction is increased. When the blower fan Mc is used, even in a dark bedroom, the user only presses the acceleration sensor Md to be able to transmit data (user's indication of intention) to the host device 300. The host device 300 receiving the data transmits, by a preset procedure, data to the IoT module 302 having the function providing device of the blower fan or the like and the external IoT module 303 such as the indoor lighting, and thereby can operate the indoor lighting, the blower fan and the like.

FIG. 19 (e) shows a cushion member Ue which includes a microphone Me1 (IoT module 301) having a communication function thereinside and an LED lighting device Me2 (IoT module 302) having a communication function and is in the shape of a rectangular parallelepiped and in which the height of an end in the forward/backward direction is increased. When the cushion member Ue is used, even in a dark bedroom, the user only speaks into the microphone Me1 to be able to transmit data (user's indication of intention) to the host device 300. The host device 300 receiving the data can operate the LED lighting device Me2 and the like by a preset procedure. In a case where the host device 300 is a device such as a smartphone which has a telephone function, a configuration may be adopted in which the user speaks into the microphone Me1 to be able to answer the telephone (talk on the telephone) by this voice.

FIG. 19 (f) shows a cushion member Uf which includes a plurality of cylindrical airbags Mf (IoT modules 301) having a communication function thereinside and is in the shape of a rectangular parallelepiped. When the cushion member Uf is used, the internal pressure of the cylindrical airbags Mf is changed, and thus the repulsive force (ease of deformation) of the cushion member Uf can be changed without the height of the upper surface of the cushion member being changed. In the cylindrical airbags Mf, an air pump Mfa which can feed air into the cylindrical airbags Mf or discharge air inside the cylindrical airbags Mf is provided, and thus the internal pressure of the airbags Mf can be changed according to data transmitted from the host device 300.

FIG. 19 (g) shows a cushion member Ug which includes an airbag Mg (IoT module 302) having a communication function in a lower part of the cushion member, is in the shape of a rectangular parallelepiped and has a two-layer structure. When the cushion member Ug is used, the volume of the airbag Mg is changed, and thus the height of the upper surface of the cushion member can be changed. In the airbag Mg, an air pump Mga which can feed air into the airbag Mg or discharge air inside the airbag Mg is provided, and thus the height of the airbag Mg can be changed according to data transmitted from the host device 300. FIG. 19 (g) shows, on the right side, a state where air is fed into the airbag Mg, and shows, on the left side, a state where air is not fed into the airbag Mg.

The mattress utilizing the cushion members illustrated in FIG. 19 includes: the mattress cushion which includes a plurality of cushion members; and the mattress cover which contains the mattress cushion. The mattress cushion includes the cushion members which can be separated, and at least one or more of the cushion members include an electronic component which has a communication function. In the mattress utilizing the cushion members illustrated in FIG. 19, each of the cushion members is formed with the filament three-dimensional bonded member which includes a plurality of filaments, and includes a contact surface which is in contact with another cushion member adjacent to the cushion member. Furthermore, in the mattress, ends of the filaments of the cushion member (cut ends of the filaments and projections of loops of the filaments) do not enter the other cushion member adjacent to the cushion member (in other words, do not enter the inside of the contact surface of the other cushion member adjacent to the cushion member).

Hence, in the mattress, the contact friction force of the cushion member including the electronic component having the communication function can be decreased, and thus it is easy for the user to fit the cushion member into a desired position. In the mattress utilizing the cushion members illustrated in FIG. 19, the ends of the filaments of the cushion member do not protrude outward of the contact surface in all regions of the contact surface. Therefore, the entrance of the ends of the filaments into the other adjacent cushion member is reliably prevented.

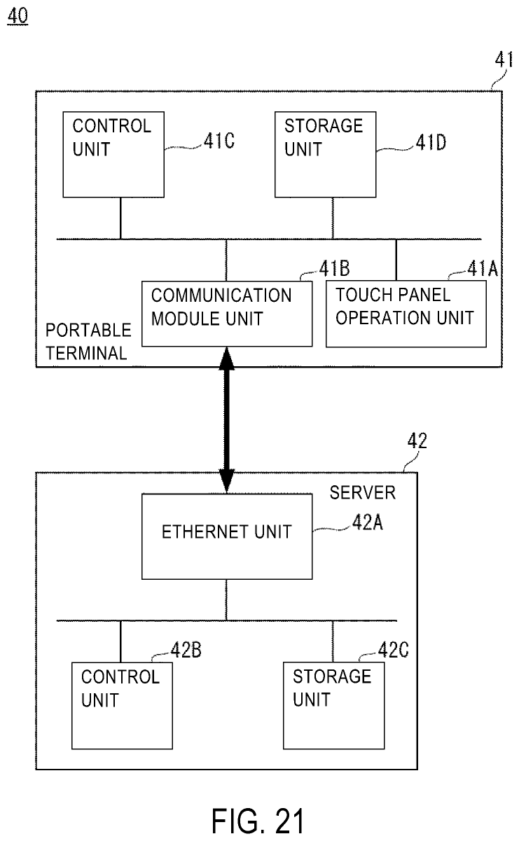

Then, an order reception system which can be utilized for the reception of an order for the mattress 200 according to the third embodiment by an orderer will be described. FIG. 21 is a block configuration diagram showing an example of the configuration of the order reception system. The order reception system 40 shown in FIG. 21 includes a portable terminal 41 which serves as an example of a communication terminal on the side of the orderer and a server 42 which servers as an example of a communication terminal on the side of an order receiver. Although in FIG. 21, the portable terminal 41 is a smartphone as an example, the portable terminal 41 may be a tablet, a cell phone or the like. The communication terminal on the side of the orderer is not limited to the portable terminal, and may be a PC (personal computer) or the like.

As shown in FIG. 21, the portable terminal 41 includes a touch panel operation unit 41A, a communication module unit 41B, a control unit 41C and a storage unit 41D. The touch panel operation unit 41A is included in a liquid crystal display unit and is touched, and thus it is possible to operate the portable terminal 41. The communication module unit 41B performs, for example, 4G communication (such as WiMAX2 or LTE-Advanced). The control unit 41C is, for example, a CPU, and controls the entire portable terminal 41. The storage unit 41D includes a ROM in which programs are stored, a RAM in which data is stored and the like.

As shown in FIG. 21, the server 42 includes an Ethernet unit 42A, a control unit 42B and a storage unit 42C. The Ethernet unit 42A is an Ethernet interface which is provided for performing IP communication with other devices (such as the portable terminal 41). The control unit 42B is, for example, a CPU, and controls the entire server 42. The storage unit 42C includes, for example, an HDD (hard disk drive), a RAM and the like.

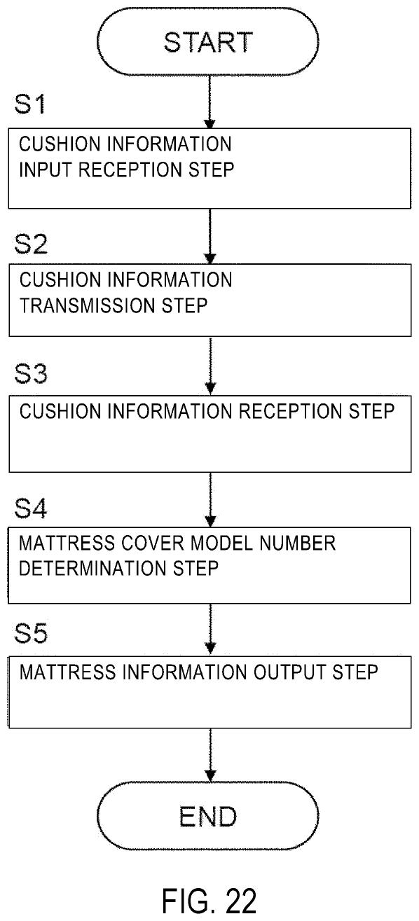

A method for receiving an order for the mattress 200 which uses the order reception system 40 configured as described above will be described with reference to a flowchart shown in FIG. 22.

A cushion information input reception step (step S1) will first be performed. In this step, the orderer operates the touch panel operation unit 41A to perform an operation of inputting cushion information. Here, the orderer performs the input operation according to a Web screen which is displayed on the display unit of the portable terminal 41 based on data transmitted from the Ethernet unit 42A of the server 42 and received by the communication module unit 41B.

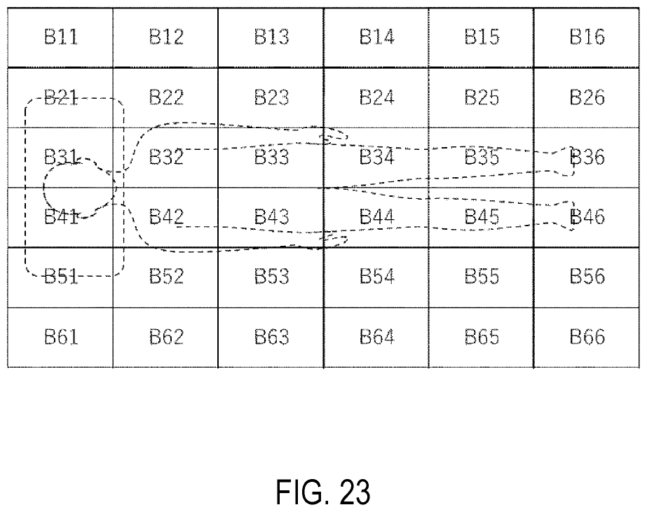

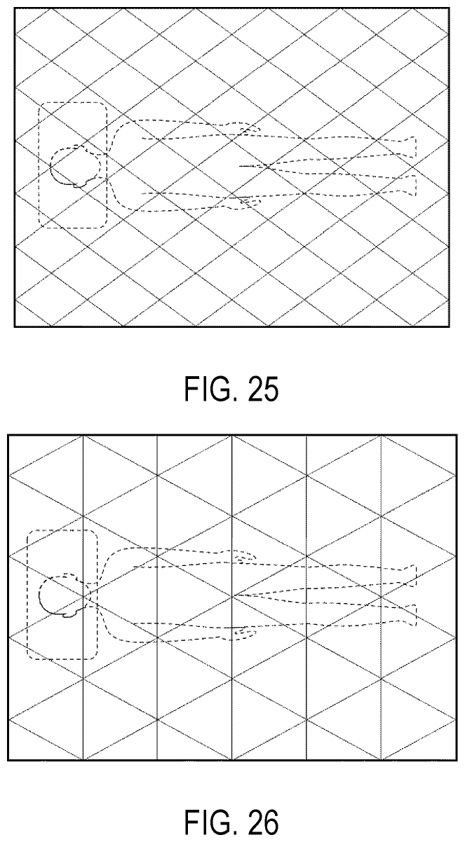

Here, FIG. 23 shows an example of partition position numbers (numbers assigned to positions of different partitions) which are used when the mattress 200 is ordered. The “partition” here means a partition (block) in which one cushion member is arranged in plan view. Rectangular outer edges in FIG. 23 correspond to rectangular outer edges of the mattress 200 in plan view, and positions inside the rectangular outer edges correspond to positions when the mattress 200 is viewed from above. In FIG. 23 (the same is true in FIGS. 25 to 29 described later), the approximate positions of a user and a pillow when only the user lies on the mattress are indicated by dashed lines.

As shown in FIG. 23, in the mattress cushion 220, a total of 36 partitions which are obtained by dividing the mattress cushion 220 into six parts in the length direction and dividing the mattress cushion 220 into six parts in the left/right direction are set, and cushion members are arranged in these partitions. A cushion member corresponding to a partition position number Bx (x is a number) shown in FIG. 23 corresponds to a cushion member Qx in the example shown in FIGS. 13 and 14. For example, the cushion member corresponding to a partition position number B11 shown in FIG. 23 corresponds to the cushion member Q11 in the example shown in FIGS. 13 and 14.

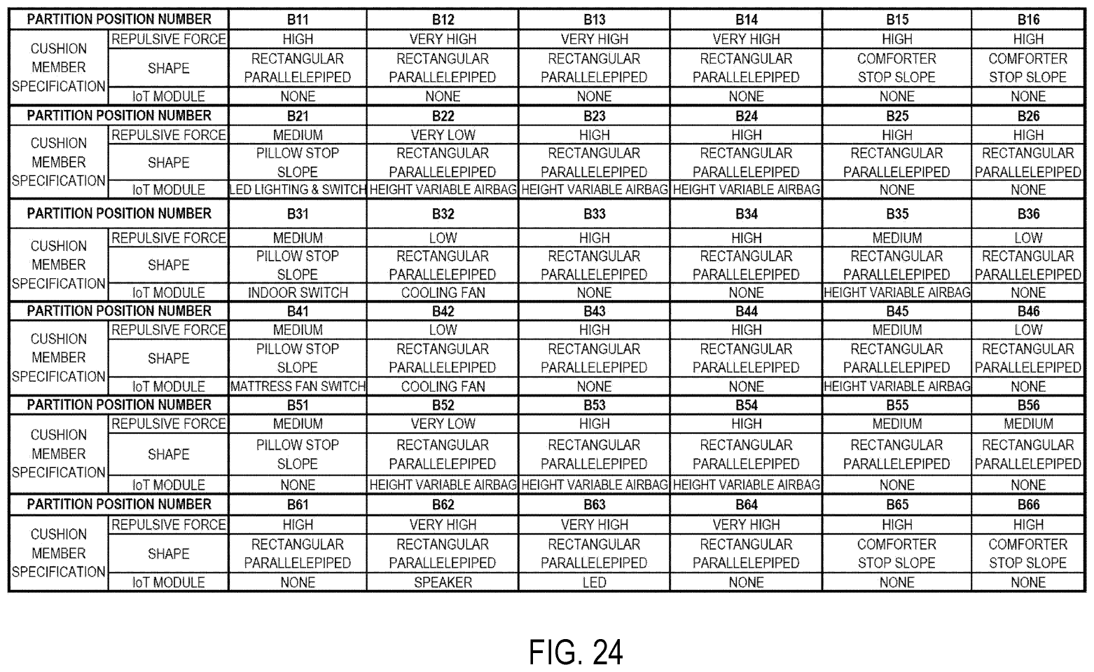

FIG. 24 shows an example of a mattress order form which is used when the mattress 200 is ordered. As shown in FIG. 24, when an order is placed, the order can be placed for each of cushion members in different partitions by specifying the magnitude of the repulsive force of the cushion member, the shape of the cushion member, whether or not the IoT module is provided in the cushion member and the type of IT module. In an example shown in FIG. 24, for the cushion member corresponding to the partition position number B11, a “high” repulsive force, the shape of a “rectangular parallelepiped”, “none” of the IoT module (that is, the IoT module is not provided) are specified.

As described above, in the cushion information input reception step, an input of the cushion information about the cushion member in each of the partitions in which the cushion members Q11 to Q66 are individually arranged is received by the communication terminal (portable terminal 41) on the side of the orderer. The cushion information includes information on the repulsive force of the cushion member in each of the partitions, information on the shape thereof and information on the electronic component having a communication function which is provided (information on whether or not the IoT module is provided and on the type). In the portable terminal 41, the cushion information which is input is stored in the storage unit 41D, and thus the input of the cushion information is received.

Then, a cushion information transmission step (step S2) is performed. In this step, in the portable terminal 41, the cushion information stored in the storage unit 41D is transmitted by the communication module unit 41B to the server 42.

Then, a cushion information reception step (step S3) is performed. In this step, in the server 42, the cushion information transmitted from the communication module unit 41B is received by the Ethernet unit 42A. The received cushion information is stored in the storage unit 42C.

Then, a mattress cover model number determination step (step S4) is performed. In this step, in the server 42, the control unit 42B automatically determines the model number of an optimal mattress cover based on the cushion information stored in the storage unit 42C. More specifically, a unique model number is previously assigned to each of a plurality of types of mattress covers having different shapes and the like. With consideration given to the shapes of the cushion members, the functions of the IoT modules, the positions of the cushion members and the like which are found from the cushion information, the optimal mattress cover is selected from the types of mattress covers, and the model number of the mattress cover which is selected is determined as the model number of the optical mattress cover.

In the process of selecting the optical mattress cover from the types of mattress covers, for example, with consideration given to the shape of the cushion member which is adopted, whether or not an airbag function is provided by the IoT module and the like, whether or not the mattress cover of the shape and the dimension suitable for the mattress cushion 220 is provided is considered. For example, with consideration given to whether or not the functions of a microphone, an LED lighting, a blower fan and the like are provided, whether or not the mattress cover which can effectively exert the functions is provided is considered.

Then, a mattress information output step (step S5) is performed. In this step, in the server 42, information (mattress information) which includes the cushion information, the model number of the mattress cover that is determined and the like is output.

The output of the mattress information is performed, for example, by transmitting the mattress information from the Ethernet unit 42A to an external manufacturing device. In this case, the manufacturing device can manufacture the mattress based on the received mattress information. The output of the mattress information may be performed, for example, by displaying the mattress information on an unillustrated display unit included in the server 42. In this case, an operator can manufacture the mattress according to the displayed mattress information. The manufactured mattress is provided to an orderer, and thus the orderer can utilize the ordered mattress.

Although in the third embodiment, the shape of the partitions in which the cushion members are arranged is rectangular, the shape of the partitions is not particularly limited. For example, as shown in FIGS. 25 to 29, the shape of the partitions in which the cushion members are arranged may be, for example, rhombic, triangular or hexagonal. As each of the cushion members arranged in the partitions, the cushion member of a column whose bottom surface is approximately congruent with its partition is adopted.

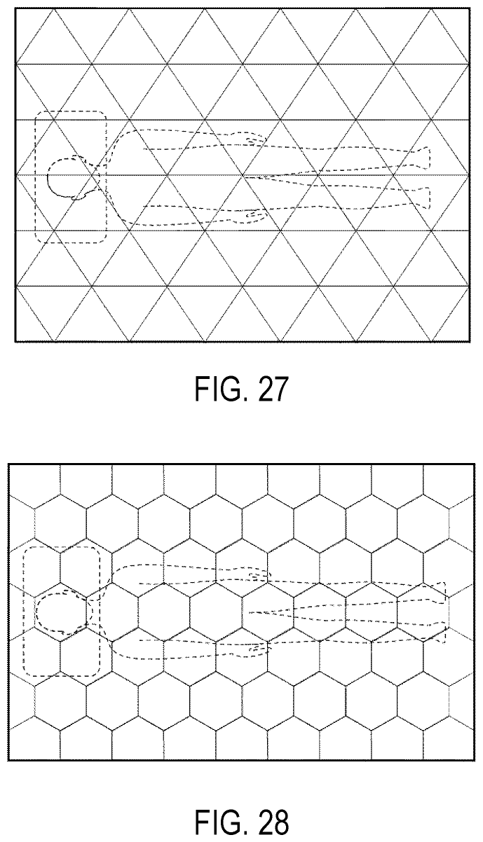

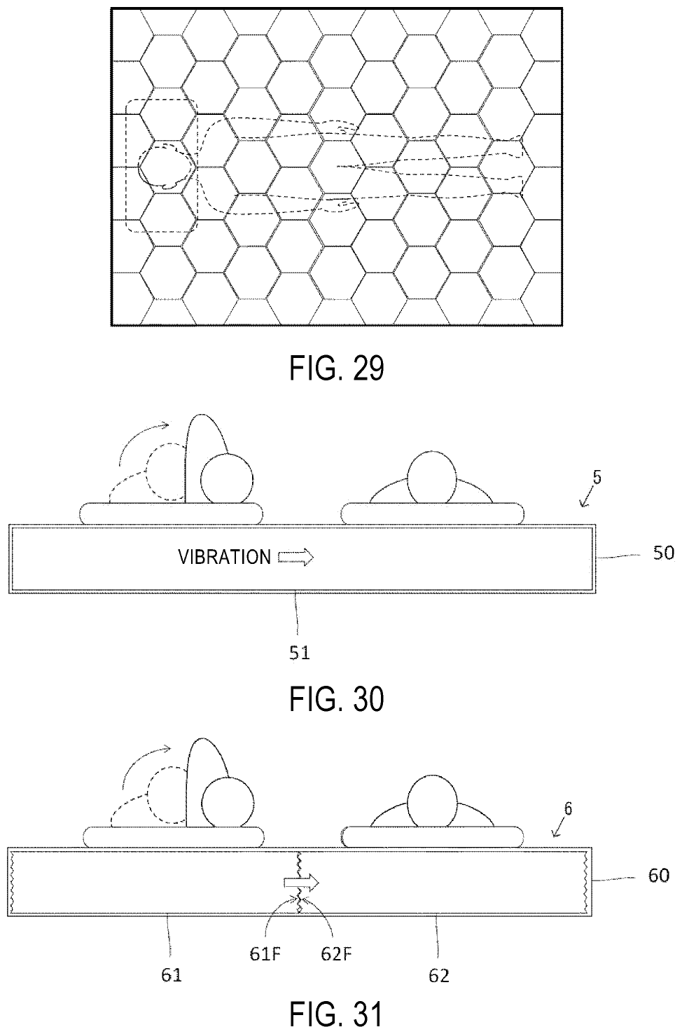

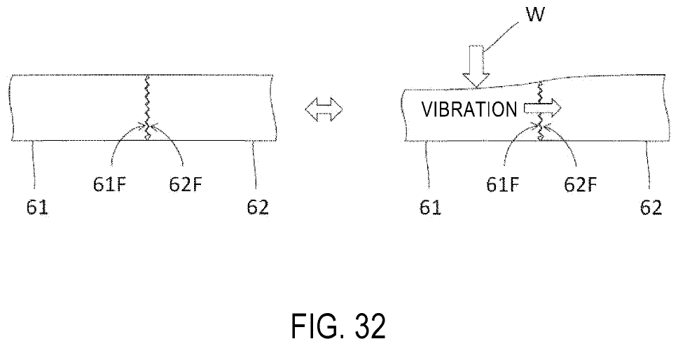

In FIGS. 25 to 29, rectangular outer edges correspond to the outer edges of the mattress 200 in plan view, and solid lines inside the rectangular outer edges indicate boundaries between partitions adjacent to each other. FIG. 25 illustrates the arrangement of the partitions when the shape of the partitions is mainly rhombic, FIGS. 26 and 27 illustrate the arrangement of the partitions when the shape of the partitions is mainly equilateral triangular and FIGS. 28 and 29 illustrate the arrangement of the partitions when the shape of the partitions is mainly regular hexagonal.

Although the embodiments of the present invention have been described above, the configuration of the present invention is not limited to the embodiments, and various modifications can be made without departing from the spirit of the invention. In other words, it should be considered that the embodiments are illustrative in all respects and not restrictive. The technical scope of the present invention is indicated not by the description of the embodiments but by the scope of claims, and it should be understood that meanings equivalent to the scope of claims and all modifications in the scope are included therein.

### INDUSTRIAL APPLICABILITY

The present invention can be utilized for mattresses of various applications.

### REFERENCE SIGNS LIST

1 mattress
5 mattress
6 mattress
10 mattress cover
11 upper surface side cover
12 bottom surface side cover
13 fastener
20 mattress cushion
21 to 26 cushion member
21f to 26f contact surface
30 flat plate
40 order reception system
41 portable terminal
42 server
50 mattress cover
51 cushion member
60 mattress cover
61, 62 cushion member
121, 124 cushion member
130 roller
200 mattress
210 mattress cover
213 fastener
220 mattress cushion
270 overlay mattress
280 mattress cushion
290 mattress
300 host device
301 IoT module including information collection device
302 IoT module including function providing device
303 external IoT module
320, 420, 520. 620, 720 mattress cushion
C conveyer
Da to Df cushion member
FL filament three-dimensional bonded member
FL1 cut surface
H heater
Ma temperature/humidity sensor
Mb touch sensor
Mc blower fan
Md acceleration sensor
Me1 microphone
Me2 LED lighting device
Mf cylindrical airbag
Mfa air pump
Mg airbag
Mga air pump
Q11 to Q66
cushion member
R roller
Ua to Ug cushion member
Xa cut surface smoothing device

1. A mattress comprising:
a mattress cushion on which a plurality of persons is capable of laying in a left/right direction,
wherein the mattress cushion includes a plurality of cushion members which is capable of being separated in the left/right direction,
each of the cushion members is formed with a filament three-dimensional bonded member which includes a plurality of filaments, and includes a contact surface which is in contact with an other cushion member adjacent to the cushion member, and
ends of the filaments of the cushion member do not enter the other cushion member adjacent to the cushion member.

2. The mattress according to claim 1,
wherein in the cushion member, the ends of the filaments do not protrude outward of the contact surface in all regions of the contact surface.

3. The mattress according to claim 1,
wherein a repulsive force of the cushion member is equal to or greater than 100 N and equal to or less than 200 N, and
a contact friction force on the contact surface between the cushion members adjacent to each other is greater than 0 N and less than 50 N.

4. The mattress according to claim 1,
wherein the cushion member includes a smooth surface layer in the contact surface.

5. A mattress comprising:
a mattress cushion which includes a plurality of cushion members; and
a mattress cover which contains the mattress cushion,
wherein the mattress cushion includes the cushion members which is capable of being separated,
at least one or more of the cushion members include an electronic component which has a communication function,
each of the cushion members is formed with a filament three-dimensional bonded member which includes a plurality of filaments, and includes a contact surface which is in contact with an other cushion member adjacent to the cushion member and
ends of the filaments of the cushion member do not enter the other cushion member adjacent to the cushion member.

6. The mattress according to claim 5,
wherein in the cushion member, the ends of the filaments do not protrude outward of the contact surface in all regions of the contact surface.

7. A method for receiving an order for the mattress according to claim 5 in which the cushion members are contained in the mattress cover, the method comprising:
a cushion information input reception step of receiving, by a first communication terminal on a side of an orderer, an input of cushion information about the cushion member in each of partitions in which the cushion members are individually arranged;
a cushion information transmission step of transmitting the cushion information the input of which has been received to a second communication terminal on a side of an order receiver;
a cushion information reception step of receiving the transmitted cushion information by the second communication terminal; and
a mattress cover model number determination step of determining a model number of the mattress cover based on the received cushion information,
wherein the cushion information includes at least information of a shape of the cushion member in each of the partitions.

8. The mattress according to claim 2,
wherein a repulsive force of the cushion member is equal to or greater than 100 N and equal to or less than 200 N, and
a contact friction force on the contact surface between the cushion members adjacent to each other is greater than 0 N and less than 50 N.

9. The mattress according to claim 2,
wherein the cushion member includes a smooth surface layer in the contact surface.

10. A method for receiving an order for the mattress according to claim 6 in which the cushion members are contained in the mattress cover, the method comprising:
a cushion information input reception step of receiving, by a first communication terminal on a side of an orderer, an input of cushion information about the cushion member in each of partitions in which the cushion members are individually arranged;
a cushion information transmission step of transmitting the cushion information the input of which has been received to a second communication terminal on a side of an order receiver;
a cushion information reception step of receiving the transmitted cushion information by the second communication terminal; and
a mattress cover model number determination step of determining a model number of the mattress cover based on the received cushion information,
wherein the cushion information includes at least information of a shape of the cushion member in each of the partitions.
